(19) United States
(12) Patent Application Publication
(10) Pub. No.: US 2024/0017413 A1
(43) Pub. Date: Jan. 18, 2024

(54) INFORMATION PROCESSING METHOD, INFORMATION PROCESSING APPARATUS, ROBOT SYSTEM, MANUFACTURING METHOD OF PRODUCT, AND STORAGE MEDIUM

(71) Applicant: CANON KABUSHIKI KAISHA, Tokyo (JP)

(72) Inventors: SATOSHI SUGAYA, Kanagawa (JP); HIRONOBU SASAKI, Kanagawa (JP)

(21) Appl. No.: 18/350,275

(22) Filed: Jul. 11, 2023

(30) Foreign Application Priority Data
Jul. 15, 2022 (JP) 2022-114130

(51) Int. Cl. B25J 9/16

(52) U.S. Cl. CPC B25J 9/1671; B25J 9/1664

(57) ABSTRACT

An information processing method includes in performing an interference confirmation between a first component and a second component, executing a threshold setting processing of setting a threshold for a piece of information that defines a movement of the first component or the second component, and executing an interference confirmation processing of performing the interference confirmation using the threshold set for the information.

### BACKGROUND OF THE INVENTION

### Field of the Invention

The present invention relates to an information processing method, an information processing apparatus, a robot system, a manufacturing method of a product, and a storage medium.

### Description of the Related Art

Heretofore, confirmation of movement of a robot is performed in advance using an interference check so that the robot does not collide with a surrounding environment when the robot is moved. In the interference check, distance between target objects is calculated, and in a state where the calculated distance is equal to or smaller than a threshold set to execute the interference check between target objects, it is determined that interference may occur. A method for setting an individual threshold for each of the target objects in setting thresholds for target objects of the interference check is disclosed (refer to Japanese Patent Application Laid-Open Publication No 2021-110885).

### SUMMARY OF THE INVENTION

According to a first aspect of the present invention, an information processing method includes in performing an interference confirmation between a first component and a second component, executing a threshold setting processing of setting a threshold for a piece of information that defines a movement of the first component or the second component, and executing an interference confirmation processing of performing the interference confirmation using the threshold set for the information.

According to a second aspect of the present invention, an information processing apparatus includes in performing an interference confirmation between a first component and a second component, executing a threshold setting processing of setting a threshold for an information that defines a movement of the first component or the second component, and executing an interference confirmation processing of performing the interference confirmation using the threshold set for the information.

Further features of the present invention will become apparent from the following description of exemplary embodiments with reference to the attached drawings.

### BRIEF DESCRIPTION OF THE DRAWINGS

FIG. 1 is a schematic drawing of a robot system according to a first embodiment of the present invention.

FIG. 2 is a control block diagram of a control apparatus equipped in a robot apparatus according to the first embodiment of the present invention.

FIG. 3 is a schematic drawing of an information processing apparatus according to the first embodiment of the present invention.

FIG. 4 is a control block diagram of the information processing apparatus according to the first embodiment of the present invention.

FIG. 5 is a diagram illustrating a simulation screen displayed on a display of the information processing apparatus according to the first embodiment of the present invention.

FIG. 6 is a flowchart illustrating an interference check executed by the information processing apparatus according to the first embodiment of the present invention.

FIG. 7 is a view illustrating a program setting screen displayed on the display of the information processing apparatus according to the first embodiment of the present invention.

FIG. 8 is a view illustrating a movement of the robot apparatus based on a command entered to a program setting according to the first embodiment of the present invention.

FIG. 9 is a flowchart illustrating an interference check executed by an information processing apparatus according to a second embodiment of the present invention.

FIG. 10 is a diagram illustrating a program file setting screen displayed on a display of the information processing apparatus according to a second embodiment of the present invention.

FIG. 11 is a flowchart illustrating an interference check executed by an information processing apparatus according to a third embodiment of the present invention.

FIG. 12 is a view illustrating a process setting screen displayed on a display of the information processing apparatus according to the third embodiment of the present invention.

FIG. 13 is a flowchart illustrating an interference check executed by an information processing apparatus according to a fourth embodiment of the present invention.

FIG. 14A is a diagram illustrating a screen for setting threshold to be used classified by velocity that is displayed on a display of the information processing apparatus according to the fourth embodiment of the present invention.

FIG. 14B is a diagram illustrating a state in which a velocity rate entry has been added.

FIG. 15A is a diagram illustrating the screen for setting a threshold to be used on a time chart that is displayed on the display of the information processing apparatus according to the fourth embodiment of the present invention.

FIG. 15B is a diagram illustrating a state in which a division time entry has been added.

### DESCRIPTION OF THE EMBODIMENTS

In a configuration in which thresholds are set for each of the components being the target of interference check, as in the robot control apparatus disclosed in Japanese Patent Application Laid-Open Publication No. 2021-110885, a number of thresholds corresponding to the number of components being the target of interference check must be set. Therefore, for example, if it is desirable to execute the interference check by setting different thresholds for different movements of the robot control apparatus, it was necessary to set different thresholds to execute the interference check for different movements of the respective components, such that the operation was complex.

### First Embodiment

Now, an embodiment for carrying out the present technique will be described in detail with reference to the drawings. The configuration illustrated below is merely an example, and detailed configurations can be varied arbitrarily by those skilled in the art without deviating from the concept of the present invention. Further, the numerical values illustrated in the following description are reference values, and they are merely examples.

### Configuration of Robot System

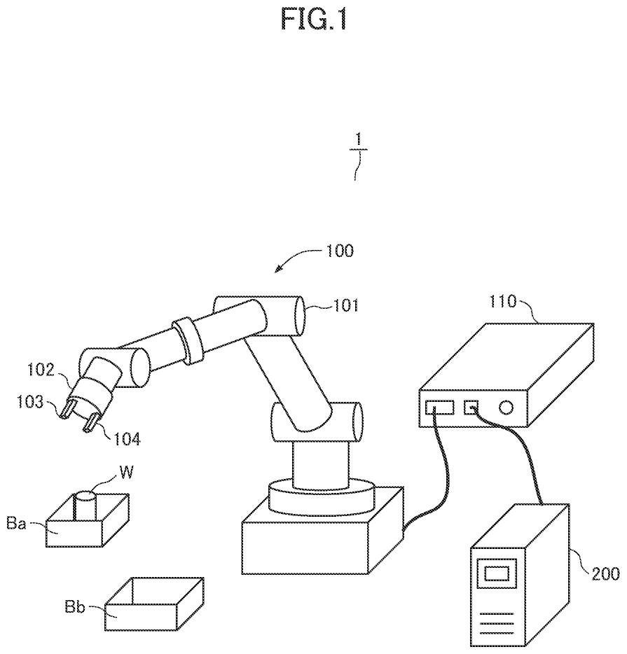

FIG. 1 is a view illustrating a general configuration of a robot system 1 according to a first embodiment of the present invention. As illustrated in FIG. 1, the robot system 1 includes a robot apparatus 100 serving as an industrial robot, a control apparatus 110 that performs control to move the robot apparatus 100, and an information processing apparatus 200 serving as a teaching device, that is, a simulator.

The robot apparatus 100 is used for purposes such as manufacturing, conveying, and picking products. The robot apparatus 100 includes a hand 102, which is an example of an end effector and which serves as a robot hand capable of gripping a work W, and an arm 101 having the hand 102 disposed on a tip thereof and serving as a robot arm that controls the position of the hand 102 and that has a plurality of joints. The robot apparatus 100 is positioned and arranged on a stand or a floor surface not shown, for example.

The hand 102 has a first finger 103 and a second finger 104, and includes a motor not shown for driving the first finger 103 and the second finger 104 disposed in an interior thereof, wherein by the motor being driven, the first finger 103 and the second finger 104 are moved toward or away from each other. When gripping the work W, the hand 102 causes the first finger 103 and the second finger 104 to move toward one another and to contact the work W. That is, the hand 102 functions as a tool for gripping the work W by the first finger 103 and the second finger 104.

The work W is stored in a small box Ba in a periphery of the robot apparatus 100. Further, an empty large box Bb is arranged in the periphery of the robot apparatus 100. In the first embodiment, an operation is assumed in which the work W is moved from the small box Ba to the large box Bb using the robot apparatus 100.

The control apparatus 110 controls the arm 101 and the hand 102 based on a movement information of the arm 101 and the hand 102, that is, based on a trajectory control data, or teaching data, for creating a trajectory of the arm 101 and the hand 102. The control apparatus 110 acquires the teaching data from the information processing apparatus 200. The teaching data includes command information and teaching point information. The control apparatus 110 according to the first embodiment moves the arm 101 and the hand 102 based on the teaching data to cause the robot apparatus 100 to grip the work W arranged in the small box Ba. The robot apparatus 100 moves the arm 101 and the hand 102 while gripping the work W to thereby convey the work W to the large box Bb.

The information processing apparatus 200 is composed of a computer and functions as a teaching device, that is, a simulator. In the first embodiment, the information processing apparatus 200 creates the teaching data through computer simulation, that is, through off-line teaching, and performs simulation to confirm the movement of the robot apparatus 100 in advance. As described above, the information processing apparatus 200 outputs the created teaching data to the control apparatus 110. The information processing apparatus 200 outputs the teaching data through cable communication to the control apparatus 110. Alternatively, regarding the method for outputting the teaching data, the information processing apparatus 200 can be configured to output the teaching data to the control apparatus 110 through wireless communication instead of through cable communication.

### Control Block Diagram of Control Apparatus

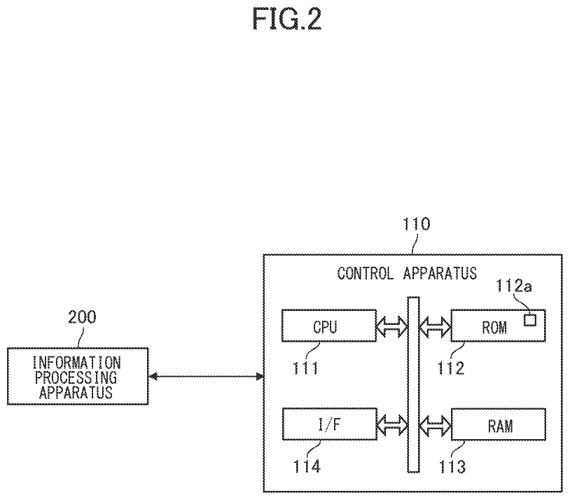

FIG. 2 is a control block diagram of the control apparatus 110. As illustrated in FIG. 2, the control apparatus 110 is composed of a computer including a microprocessor. As illustrated in FIG. 2, the control apparatus 110 includes a Central Processing Unit (CPU) 111, a Read Only Memory (ROM) 112, and a Random Access Memory (RAM) 113. Further, the control apparatus 110 includes a communication interface (hereinafter referred to as “I/F”) 114.

A program 112a is stored in the ROM 112. The program 112a is a program for having a computer, that is, the CPU 111, execute a method for controlling the robot apparatus 100. The RAM 113 is used to temporarily store the teaching data received from the information processing apparatus 200 or data such as a control command. The CPU 111 acquires the teaching data output from the information processing apparatus 200 by receiving the data through the I/F 114. Further, the CPU 111 creates a trajectory of each axis of the robot apparatus 100 based on the teaching data and transmits a command as a control target value through the I/F 114 to the robot apparatus 100.

According to the first embodiment, the program 112a is stored in the ROM 112, but the present technique is not limited thereto. The program 112a can be stored in any storage medium, as long as it is a computer-readable non-transitory storage medium. The storage medium for supplying the program 112a to the computer can be, for example, a flexible disk, a hard disk, an optical disk, a magneto-photo disk, a magnetic tape, and a nonvolatile memory.

### Configuration of Information Processing Apparatus

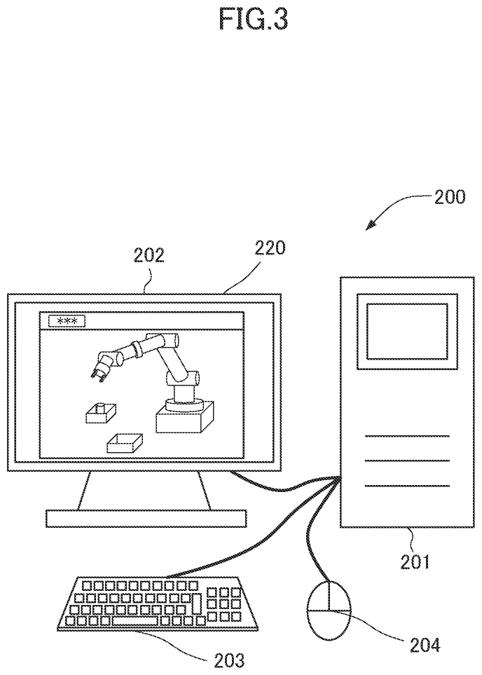

FIG. 3 is an explanatory view of the information processing apparatus 200 according to the first embodiment. The information processing apparatus 200 includes an apparatus body 201, a display 202 which is an example of a display apparatus connected to the apparatus body 201, and a keyboard 203 and a mouse 204 which are examples of an input apparatus connected to the apparatus body 201. Hereafter, an example in which the information processing apparatus 200 is a desktop personal computer serving as a general-purpose computer is described, but the present technique is not limited thereto. The information processing apparatus 200 can be other general-purpose computers such as a laptop PC, a tablet PC, and a smartphone, or a teaching pendant, or a simulator-dedicated computer. Further, the information processing apparatus 200 can be incorporated in the control apparatus 110. That is, the control apparatus 110 can include the function of a simulator.

The display 202 for displaying information displays a simulation screen 220 through which the user performs teachings of the robot apparatus 100, edits the program, moves the robot apparatus 100, and confirms interference between components included in the robot system 1. An image displayed on the screen of the display 202 is updated every 1/60 seconds (approximately 16.7 ms). In other words, the display 202 serving as the display apparatus displays information communicated by the control apparatus 110 and the information processing apparatus 200.

The display 202 can also be formed by laminating a so-called touch panel on the surface. If a touch panel is laminated on the surface, an input operation equivalent to those performed using input apparatuses such as the keyboard 203 and the mouse 204 can be performed through the touch panel on the display 202. According to this configuration, the information processing apparatus 200 can adopt a configuration in which an input apparatus other than the display 202 is not included.

The information processing apparatus 200 according to the first embodiment is configured to enable confirmation of whether interference occurs in the movement of the arm 101 and the hand 102 mainly in an offline environment. Further, the operation of entering, editing and changing various information of the simulator of the robot system 1 is configured to be performed through the input apparatus such as the keyboard 203 and the mouse 204.

The simulation screen 220 of FIG. 3 includes at least a virtual space screen. The virtual space screen can be configured as a Graphical User Interface (GUI). In that case, the information processing apparatus 200 is configured to enable objects, such as a menu, an entry field for entering numerical values and characters, and a virtual display of the robot, constituting the simulation screen 220 to be operated using a pointing device such as a mouse 204. In a state where the display 202 of the information processing apparatus 200 is configured as a touch panel described above, the objects constituting the simulation screen 220 can be operated through the touch panel.

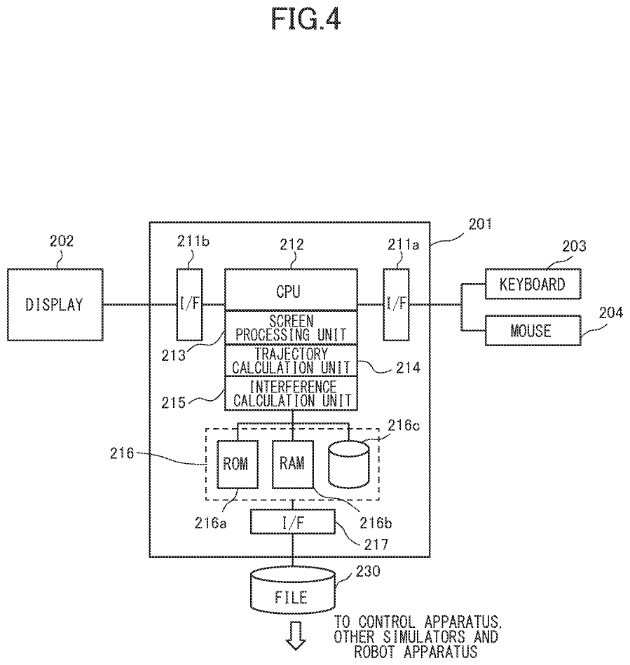

FIG. 4 is a control block diagram illustrating a control system of the information processing apparatus 200. As illustrated in FIG. 3, the apparatus body 201 of the information processing apparatus 200 includes, as hardware, a CPU 212, and a storage apparatus 216 including a ROM 216a, a RAM 216b, and a Hard Disk Drive (HDD) 216c.

Further, the apparatus body 201 includes an I/F 211a for communicating and connecting with the input apparatus such as the keyboard 203 and the mouse 204, and an I/F 211b for communicating and connecting with the display 202. Further, the apparatus body 201 includes an I/F 217 for transmitting and receiving data in the form of a file 230 with external apparatus such as the control apparatus 110, other simulators and robot apparatuses. These interfaces are composed, for example, of serial and parallel buses and network interfaces.

The ROM 216a is a non-transitory storage apparatus. A basic program read by the CPU 212 when starting the computer is stored in the ROM 216a. The RAM 216b is a transitory storage apparatus that is used to perform arithmetic processing of the CPU 212. The HDD 216c is a non-transitory storage apparatus that stores various data such as the result of arithmetic processing of the CPU 212. A program that functions as an application software is stored in the HDD 216c according to the first embodiment. By executing the program stored in the HDD 216c, the CPU 212 functions as an information processing unit capable of simulating behaviors of a virtual robot, i.e., arm and hand, and a virtual work in a virtual environment described below.

In the first embodiment, the computer readable non-transitory storage medium is the HDD 216c, and a program functioning as the application software is stored in the HDD 216c, but the present technique is not limited thereto. The program can be stored in any storage medium, as long as it is a computer readable non-transitory storage medium. The storage medium for installing the program to the computer can be a flexible disk, an optical disk, a magneto-photo disk, a magnetic tape, or a nonvolatile memory, for example.

The CPU 212 controls the entire system of the information processing apparatus 200. The CPU 212 includes a screen processing unit 213, a trajectory calculation unit 214, and an interference calculation unit 215 as an arithmetic processing unit.

The screen processing unit 213 performs a control operation based on input and editing operations of the simulation screen 220 performed by operating the keyboard 203 and the mouse 204. The information processing apparatus 200 creates a display control information for updating the display on the simulation screen 220 and an interference check setting information described below by the control computation of the screen processing unit 213, and stores the created setting information in the storage apparatus 216. Further, the screen processing unit 213 also performs arithmetic control based on display, input, and editing operations of thresholds of the interference check described below.

The trajectory calculation unit 214 is an arithmetic area in which the CPU 212 interprets a program for operating the robot apparatus 100 to compute a trajectory of the arm 101 and the hand 102 and output the same as a command value data, and the command value data being output is stored in the storage apparatus 216. The command value data output by the trajectory calculation unit 214 is expressed by a format such as a list of position, or angle, data of each joint of the robot for positioning a specific reference part at a specific position, i.e., teaching point.

The interference calculation unit 215 is an arithmetic area to which the command value data stored in the storage apparatus 216 is entered and that is used by the CPU 212 to execute an interference check processing described below, and outputs the result of the interference check.

The storage apparatus 216 stores a model information, which is the information of components displayed on the simulation screen 220, program and threshold setting information, the command value data output by the trajectory calculation unit 214, and the result of the interference check output by the interference calculation unit 215. The respective information stored in the storage apparatus 216 is output in response to a request from the CPU 212 or updated in response to a request from the CPU 212. Further, the CPU 212 can transmit various information stored in the storage apparatus 216 in the form of files 230 from the I/F 217 in response to a request from an external apparatus or in response to specific operations performed using the keyboard 203 or the mouse 204. Further, the file 230 from the exterior can be read through the I/F 217 according to need.

When starting or performing a restoration processing of the information processing apparatus 200, the file 230 having been output in the past from an external apparatus, i.e., external storage apparatus such as a Solid State Drive (SSD) or a Network Attached Storage (NAS), is read. The information processing apparatus 200 can restore a previous storage state by updating the storage apparatus 216. In the first embodiment, a storage area of the storage apparatus 216 for storing components can be determined arbitrarily, and for example, a predetermined area in the RAM 216b or a storage area corresponding to a predetermined file in the HDD 216c can be used.

### Simulation Screen

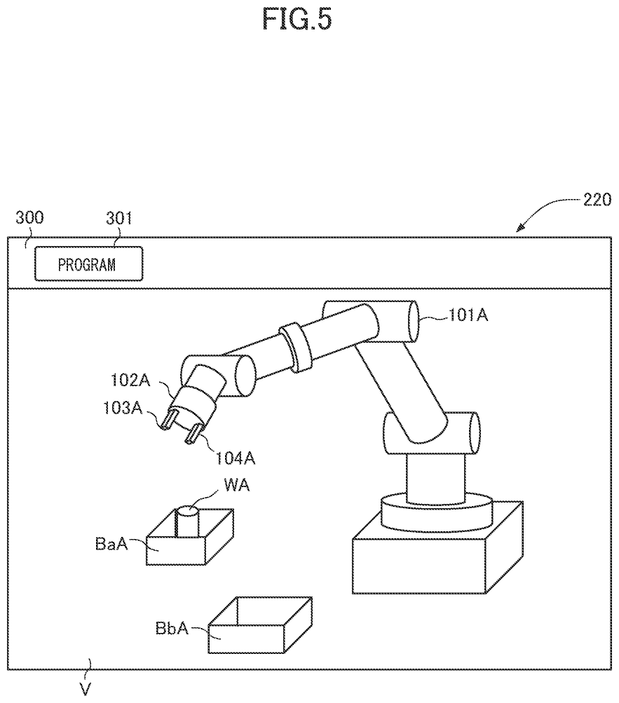

FIG. 5 is an explanatory view of the simulation screen 220 displayed on the display 202 when simulation is performed by the information processing apparatus 200 according to the first embodiment. The information processing apparatus 200 according to the first embodiment operates the robot apparatus 100 and performs various simulations according to the information displayed on the display 202.

A virtual space V serving as a virtual environment and a tool bar 300 serving as a processing menu are displayed on the simulation screen 220. Virtual objects in the virtual space V are defined by a three-dimensional model data, such as a CAD data, and for convenience, they are visualized and illustrated as a structure.

A virtual object defined in the virtual space V illustrated in FIG. 5 will be described. In the virtual space V, a three-dimensional model data simulating the robot apparatus 100, the arm 101, the hand 102, the first finger 103, the second finger 104, the work W, the small box Ba, and the large box Bb illustrated in FIG. 1 are respectively defined. As illustrated in FIG. 5, in the virtual space V, a virtual robot apparatus 100A, a virtual arm 101A, a virtual hand 102A, a virtual first finger 103A, a virtual second finger 104A, a virtual work WA, a virtual small box BaA, and a virtual large box BbA are respectively defined. The hand 102A, the first finger 103A, and the second finger 104A are defined at the tip of the arm 101A. The work WA, the small box BaA, and the large box BbA are defined in a circumference of the robot apparatus 100A.

The CPU 212 simulates a movement of gripping the work WA by the arm 101A and the hand 102A. The virtual space V is displayed by still image or moving image on the simulation screen 220 of the display 202 illustrated in FIG. 2.

The tool bar 300 is displayed on an upper portion of the simulation screen 220. A program button 301 is displayed on the tool bar 300. The program button 301 is a button for displaying a screen for creating and executing a program for operating the arm 101A and the hand 102A.

### Interference Check

The information processing apparatus 200 according to the first embodiment is configured to enable setting of the thresholds to be used for the interference check, i.e., threshold to be used, to the command of the program serving as information that defines the movements of the arm 101, the hand 102, the first finger 103, and the second finger 104 constituting the robot apparatus 100. The arm 101, the hand 102, the first finger 103, and the second finger 104 that constitute the robot apparatus 100 constitute a first component.

The information processing apparatus 200 uses the thresholds to be used that are associated with the commands of the program to execute an interference check as an interference confirmation for confirming the interference between the first component constituting the robot apparatus 100, and the work W, the small box Ba, and the large box Bb that serve as a second component.

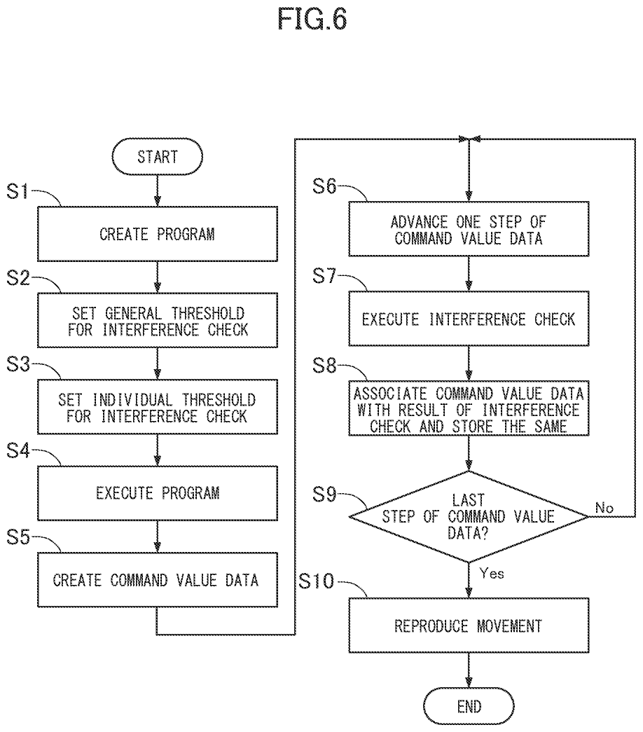

Details of the interference check executed by the information processing apparatus 200 according to the first embodiment will be described with reference to FIGS. 6 to 8. FIG. 6 is a flowchart illustrating a program setting and interference check executed by the CPU 212 of the information processing apparatus 200 according to the first embodiment. The flowchart illustrated in FIG. 6 is started by the program button 301 displayed on the simulation screen 220 being operated.

The CPU 212 performs setting of the program that is required for executing the interference check and the thresholds being used for the interference check by executing the processing of steps S1 to S3 illustrated in FIG. 6. Further, the CPU 212 executes the processing of steps S4 and S5 illustrated in FIG. 6 to create a command value data by executing the program set by the processing of steps S1 to S3. Then, the CPU 212 executes the processing of steps S6 to S10 illustrated in FIG. 6 to execute the interference check related to the command value data and to display the result of the interference check being executed.

In the robot system 1, when executing operation by gripping a plurality of works and tools, an amplitude of vibration of the arm 101 during movement also varies according to the weight of the object being gripped. Therefore, the information processing apparatus 200 according to the first embodiment can set the threshold used for the interference check for each command of the program so as to set thresholds considering the amplitude of vibration of the arm 101 that varies among different operations.

As illustrated in FIG. 6, at first, the CPU 212 creates a program (S1). In this processing, at first, the CPU 212 calls a program setting screen based on the selection of the program button 301 through the operation of the mouse 204. Then, the CPU 212 creates the program by having the program entered in the program setting screen.

Next, the CPU 212 sets a general threshold serving as a threshold that is set uniformly for the commands of the program to which individual thresholds have not been set among the thresholds used for the interference check (S2). In this processing, the CPU 212 enables to set the value entered through the program setting screen as a general threshold that is set uniformly for the commands of the program to which the individual threshold has not been set.

Next, the CPU 212 sets individual thresholds among the thresholds to be used for the interference check (S3). In this processing, the CPU 212 sets the values entered for respective commands of the program entered in the program setting as the individual thresholds.

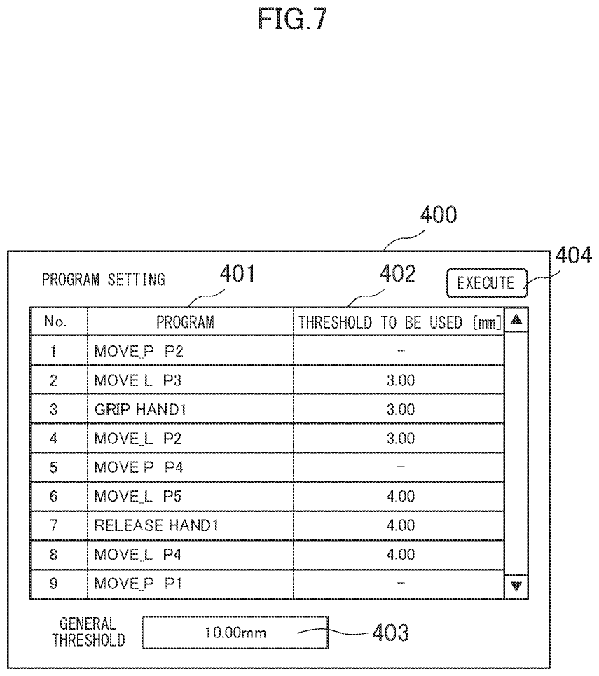

The details of steps S1 to S3 will be described in detail with reference to FIG. 7. FIG. 7 is an explanatory view of a program setting screen 400. As illustrated in FIG. 7, a program setting 401 serving as an area in which commands of the program can be entered and a threshold-to-be-used setting 402 serving as an area in which individual thresholds for respective commands can be entered are displayed on the program setting screen 400. Further, a general threshold setting 403 serving as an area for setting the general threshold set uniformly for the commands to which the individual threshold has not been set is displayed on the program setting screen 400. A program execution button 404 that causes the program entered to the program setting 401 to be executed when operated is displayed on the program setting screen 400.

In a state where the program setting 401 is selected, the CPU 212 creates a program for operating the robot apparatus 100 based on a command constituting a program entered through the operation of the keyboard 203.

Among the commands illustrated in FIG. 7, a command “MOVE_P Pn” is a command for moving the hand 102 at the tip of the arm 101 to a teaching point Pn by a joint interpolation operation. Further, a command “MOVE_L Pn” is a command for moving the arm 101 to the teaching point Pn by a linear interpolation operation. Further, a command “GRIP HAND1” is a command for gripping the work W by having the first finger 103 and the second finger 104 move toward one another. A command “RELEASE HAND1” is a command for releasing the gripped work W by moving the first finger 103 and the second finger 104 away from each other.

Joint interpolation is a control performed to evenly interpolate joint angle differences of respective shafts of the arm 101 when moving the arm 101, and linear interpolation is a control performed to realize movement such that the trajectory of the hand 102 serving as the tip of the arm 101 is linear. According to the joint interpolation operation, arrival to the teaching point is faster than the linear interpolation operation, but the trajectory of the tip is not ensured. Meanwhile, according to the linear interpolation operation, the trajectory of the tip is ensured to be linear.

In a state where the threshold-to-be-used setting 402 of the command entered to the program setting 401 is selected by the operation of the mouse 204, the screen processing unit 213 sets the value entered through the keyboard 203 as the individual threshold of the command and displays the same on the threshold-to-be-used setting 402.

In the example illustrated in FIG. 7, an individual threshold of 3.00 mm is set respectively for command No. 2 “MOVE_L P3”, command No. 3 “GRIP HAND1”, and command No. 4 “MOVE_L P2” of the program setting 401. Further according to the example illustrated in FIG. 7, an individual threshold of 4.00 mm is set respectively for command No. 6 “MOVE_L P5”, command No. 7 “RELEASE HAND1”, and command No. 8 “MOVE_L P4”. In the example illustrated in FIG. 7, “-” is displayed for commands whose individual thresholds are not set, which are command No. 1 “MOVE_P P2”, command No. 5 “MOVE_P P4”, and command No. 9 “MOVE_P P1”.

Further, in a state where the general threshold setting 403 is selected by the operation of the mouse 204, the screen processing unit 213 sets the value entered through the keyboard 203 as the general threshold ad displays the same on the general threshold setting 403.

In the example illustrated in FIG. 7, 10.00 mm is set as the general threshold, such that a 10.00 mm threshold is set for each of command No. 1 “MOVE_P P2”, command No. 5 “MOVE_P P4”, and command No. 9 “MOVE_P P1”.

The CPU 212 stores respective information of the command entered to the program setting 401, the individual threshold entered to the threshold-to-be-used setting 402, and the general threshold entered to the general threshold setting 403 in the storage apparatus 216.

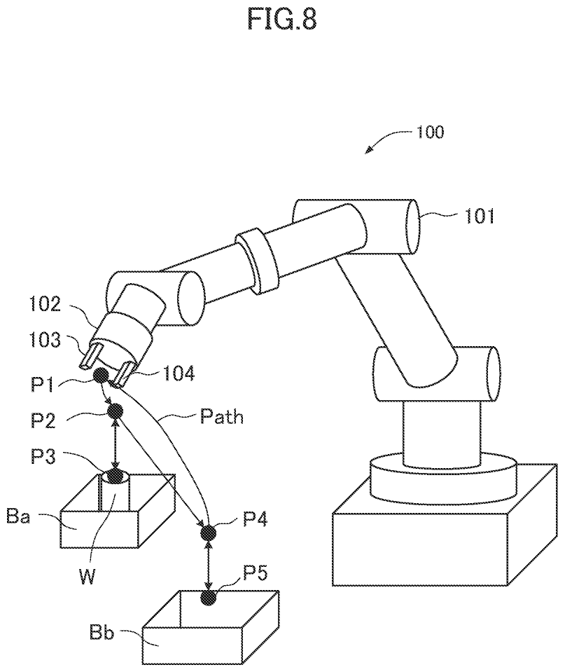

The details of the operation of the robot apparatus 100 based on the program created by the CPU 212 will be described with refence to FIGS. 7 and 8. FIG. 8 is a view illustrating an operation of the robot apparatus 100 based on the command entered to the program setting 401 illustrated in FIG. 7. In the example illustrated in FIG. 8, the program connects teaching points P1 to P5 of the arm 101A through a trajectory Path.

At first, the CPU 212 moves the arm 101 through joint interpolation operation based on the command “MOVE_P P2”, which is command No. 1 of the program setting 401, and moves the hand 102 from a teaching point P1 serving as a home position to a teaching point P2. Next, the CPU 212 moves the arm 101 through linear interpolation operation based on the command “MOVE_L P3”, which is command No. 2 of the program setting 401, and moves the hand 102 from the teaching point P2 to a teaching point P3 by linear movement.

According to the robot apparatus 100, by moving the hand 102 through linear interpolation operation in a linear trajectory, collision of the hand 102, the first finger 103, and the second finger 104 with the small box Ba when approaching the teaching point P3 in the vicinity of the work W positioned inside the small box Ba can be easily prevented.

Next, the CPU 212 causes the first finger 103 and the second finger 104 of the hand 102 to move close to each other based on a command “GRIP HAND1”, which is command No. 3 of the program setting 401, and causes the work W to be gripped by the first finger 103 and the second finger 104. Next, the CPU 212 moves the arm 101 through linear interpolation operation by a command “MOVE_L P2”, which is command No.4 of the program setting 401, and causes the hand 102 to move linearly from the teaching point P3 to the teaching point P2.

In the robot apparatus 100, the hand 102 is moved in a linear trajectory through linear interpolation operation, such that collision of the hand 102, the first finger 103, the second finger 104, and the work W with the small box Ba when moving away from the small box Ba while gripping the work W can be easily prevented.

Next, the CPU 212 moves the arm 101 through joint interpolation operation by a command “MOVE_P P2”, which is command No. 5 of the program setting 401, and moves the hand 102 from the teaching point P2 to a teaching point P4. Thereafter, the CPU 212 moves the arm 101 through linear interpolation operation by a command “MOVE_L P5”, which is command No. 6 of the program setting 401, and moves the hand 102 from the teaching point P4 to a teaching point P5 by linear movement.

In the robot apparatus 100, the hand 102 is moved through a linear trajectory, such that collision of the hand 102, the first finger 103, the second finger 104, and the work W with the large box Bb when the work W approaches the teaching point P5 where the work W can be placed in the large box Bb can be easily prevented.

Next, the CPU 212 causes the first finger 103 and the second finger 104 of the hand 102 to move away from each other by a command “RELEASE HAND1”, which is command No. 7 of the program setting 401, and releases the gripping of the work W by the first finger 103 and the second finger 104.

In the robot apparatus 100, the work W can be placed on the large box Bb by executing the command of “RELEASE HAND1”. Thereby, the robot apparatus 100 can move the work W from the small box Ba to the large box Bb.

Next, the CPU 212 causes the arm 101 to move through linear interpolation operation by a command “MOVE_L P4”, which is command No. 8 of the program setting 401, and causes the hand 102 to move from the teaching point P5 to the teaching point P4 by linear movement. Next, the CPU 212 causes the arm 101 to move through joint interpolation operation by a command “MOVE_P P1”, which is command No. 9 of the program setting 401, and causes the hand 102 to move from the teaching point P4 to the teaching point P1 serving as the home position.

As described, according to the robot system 1, by executing a program composed of commands entered to the program setting 401, the robot apparatus 100 can move the work W from the small box Ba to the large box Bb. Further, when executing the interference check described later, the information processing apparatus 200 confirms the presence of interference of respective components in a state where the robot apparatus 100 is operated based on a command entered to the program setting 401.

As described, according to the robot system 1, in a series of operations of moving to a vicinity of the work W positioned in the small box Ba in a linear trajectory, gripping the work W, and lifting the work W, the first finger 103 and the second finger 104 are respectively inserted to a clearance between the small box Ba and the work W. In other words, according to the robot system 1, interference may occur between the small box Ba and other components during the series of operations based on command Nos. 2 to 4 of the program setting 401. Therefore, the information processing apparatus 200 sets 3.00 mm as the individual threshold for command Nos. 2 to 4.

According further to the robot system 1, in a series of operations of moving in a linear trajectory while gripping the work W, placing the work W in the large box Bb, and evacuating from the large box Bb, the work W, the first finger 103, and the second finger 104 are respectively inserted to the large box Bb. In other words, according to the robot system 1, interference may occur between the large box Bb and other components during the series of operations based on command Nos. 6 to 8 of the program setting 401. Therefore, the information processing apparatus 200 sets 4.00 mm as the individual threshold for command Nos. 6 to 8.

In the robot system 1, a series of operations performing the joint interpolation operation is executed in a state where the hand 102 and the work W, the small box Ba and the large box Bb are positioned apart. In other words, according to the robot system 1, the possibility of respective components interfering with each other in the series of operations based on command Nos. 1, 5, and 9 of the program setting 401 is small. Therefore, the information processing apparatus 200 sets 10.00 mm, which is a general threshold, as the threshold for the command Nos. 1, 5, and 9.

As described, the information processing apparatus 200 of the first embodiment is configured to enable setting of the threshold to be used for performing interference check for program commands serving as information for regulating the operations of the arm 101, the hand 102, the first finger 103, and the second finger 104 serving as first components. Specifically, the information processing apparatus 200 can set the threshold to be used for performing the interference check of the first and second components even in a command that operates a plurality of components of the robot apparatus 100, such as command No. 3 of the program setting 401. Therefore, the information processing apparatus 200 enables to facilitate management of thresholds and reduce threshold setting errors regardless of the number of components being the target of the interference check.

Further, the information processing apparatus 200 is configured to enable the threshold to be used to be set independently for the respective commands of the program. Thereby, the information processing apparatus 200 can set the distance between components being the target of interference check to an appropriate distance for each command of the program.

The processing of steps S1 to S3 constitute a threshold setting processing according to the first embodiment. Further, the processing of step S2 constitutes an individual threshold setting processing according to the first embodiment, and the processing of step S3 constitutes a general threshold setting processing according to the first embodiment.

After executing the processing of step S3, the CPU 212 executes a program (S4). In this processing, the CPU 212 starts a series of programs composed of a command entered to the program setting 401 by having the program execution button 404 displayed on the program setting screen 400 illustrated in FIG. 7 selected. The CPU 212 is configured to enable the processing of steps S1 to S3 to be executed repeatedly without executing the processing of step S4 until the program execution button 404 is operated.

By executing the program, the trajectory calculation unit 214 of the CPU 212 starts to compute the movement of the arm 101A and the movement of the hand 102A that pass through a trajectory Path illustrated in FIG. 8.

Next, the trajectory calculation unit 214 creates a command value data (S5). In this processing, the trajectory calculation unit 214 creates the command value data of the arm 101A, the hand 102A, the first finger 103A, and the second finger 104A from the start to the end of the program based on the commands entered to the program setting 401. The CPU 212 associates commands of the program entered to the program setting 401 with command value data created by the trajectory calculation unit 214, and stores the command value data in the storage apparatus 216. The CPU 212 can determine which data of a specific time of the command value data corresponds to which program command by associating the commands of a program with the command value data.

Next, the CPU 212 advances one step of the command value data (S6). In this processing, the CPU 212 advances one step of the command value data, and updates the positions of the arm 101A, the hand 102A, the first finger 103A, and the second finger 104A. The CPU 212 sets the step of the command value data advanced in the processing of step S6 as a step serving as the target of the interference check.

The CPU 212 according to the first embodiment executes the processing of step S6, updates the positions of the respective components, and displays the updated result on the virtual space V. Upon executing the processing of step S6, the CPU 212 can execute the processing in the background without displaying the same on the virtual space V, so as to reduce the time required to perform the display processing to the virtual space V.

Next, the interference calculation unit 215 of the CPU 212 executes an interference check in a state where one step of the command value data is advanced (S7). In this processing, the interference calculation unit 215 acquires the threshold set per command of the program as the threshold to be used, and performs the interference check.

At first, the interference calculation unit 215 acquires the command of the program associated with the step of the command value data set in the processing of step S6 from the storage apparatus 216. Next, the interference calculation unit 215 acquires the threshold information set for the command of the acquired program from the storage apparatus 216. As described above, an individual threshold or a general threshold is set for the command of the program. In a state where an individual threshold is set for the command of the program, the interference calculation unit 215 acquires the individual threshold as the threshold to be used for the interference check, and in a state where an individual threshold is not set for the command of the program, the general threshold is acquired as the threshold to be used for the interference check.

Then, the interference calculation unit 215 checks the positions of the arm 101A, the hand 102A, the first finger 103A, and the second finger 104A updated by the processing of step S6 and whether interference occurs with the work W, the small box Ba, and the large box Bb. The interference calculation unit 215 performs interference check for determining two kinds of states, which are an interference, or interference state, and a warning, or warning state. In a state where the result having calculated the distance between components is greater than zero and equal to or smaller than the acquired threshold to be used, the interference calculation unit 215 outputs a warning state and causes the CPU 212 to store the same in the storage apparatus 216. Further, in a state where the result having calculated the distance between components is equal to or smaller than zero, the interference calculation unit 215 outputs an interference state and causes the CPU 212 to store the same in the storage apparatus 216.

Next, the CPU 212 associates the step of command value data in which the interference calculation unit 215 has performed the interference check with the interference check result, and stores the same in the storage apparatus 216 (S8). As for the associating method, an address pointer of a storage area storing the interference check result can be stored in a storage area of the command value data, for example. Further, it is possible to count the number of steps of the command value data and to store the same count together with the interference check result, and the actual method thereof is not limited.

Next, the CPU 212 determines whether interference check of the last step of the command value data has been performed (S9). In this processing, if it is determined that the step of the command value data subjected to interference check in the processing of step S7 is not the last step (No), the CPU 212 returns the processing to step S6.

As described, the CPU 212 repeats the processing of steps S6 to S9 until the interference check of the last step of the command value data has been executed. Thereby, if the step of the command value data corresponding to command No. 2 of the program setting 401 has been started, for example, the interference calculation unit 215 uses 3.00 mm as the threshold to be used to perform the interference check. Further, if the step of the command value data corresponding to command No. 6 of the program setting 401 has been started, the interference calculation unit 215 uses 4.00 mm as the threshold to be used when performing the interference check. The processing of steps S6 to S9 constitutes an interference confirmation processing according to the first embodiment.

Meanwhile, if it is determined that the step of the command value data subjected to interference check in the processing of step S7 is determined to be the last step (Yes), the CPU 212 advances the processing to step S10.

In the processing of step S10, the CPU 212 reproduces the movement (S10), and ends the setting of the program and the interference check executed by the CPU 212. In this processing, the CPU 212 reproduces the video image in which the respective components in the virtual space V are moved based on the program composed of commands entered to the program setting 401 on the display 202. The CPU 212 displays the result of the interference check simultaneously when reproducing the movement.

The CPU 212 acquires the calculated result in the processing of step S8 from the storage apparatus 216, and causes the screen processing unit 213 to execute a screen drawing processing to have the interference check result drawn in the virtual space V. The screen processing unit 213 draws an image to be displayed in the virtual space V in a manner enabling the user to easily recognize the preference of interference, to thereby notify the user of the presence of the interference state and the warning state.

For example, the screen processing unit 213 can maintain the display color of the component not determined to be in the interference state or the warning state to the display color prior to the interference check and change the display color of the component determined to be in the interference state or the warning state. Further, the screen processing unit 213 can maintain the texture of the component not determined to be in the interference state or the warning state to the texture prior to the interference check, and change the texture of the component being determined to be in the interference state or the warning state. Further, the screen processing unit 213 can display the name of the component being determined to be in the interference state or the warning state using a message box or a display of a list that displays states. Further, the screen processing unit 213 can display colors, patterns, and symbols on a graph such as a time chart display of the command value data. In these displays, the screen processing unit 213 can be configured to display the interference state and the warning state in a distinguishable manner to the user.

### Summary of First Embodiment

As described, the information processing apparatus 200 according to the first embodiment is configured to enable the threshold to be used to be set for performing interference check between the first component and the second component to the commands of the program serving as an information that defines the movement of the robot apparatus 100. The information processing apparatus 200 can easily execute the interference check in which different thresholds are set for different movements of the robot control apparatus by setting thresholds to be used for commands for moving a plurality of components of the robot apparatus 100. Further, according to this configuration, the information processing apparatus 200 can manage the thresholds easily regardless of the number of components being the target of the interference check, and to reduce threshold setting errors.

### Second Embodiment

Next, an information processing apparatus 200 according to a second embodiment will be described. The information processing apparatus 200 according to the second embodiment is configured so that thresholds to be used for the interference check can be set in a data file of a program data for operating the robot apparatus 100 as information for defining the operation of components. The information processing apparatus 200 according to the second embodiment differs in this point from the first embodiment described above. The other configurations are similar to the first embodiment, such that components that are similar to the first embodiment are denoted with the same reference numbers and control processing that are similar to the first embodiment are denoted with the same step numbers, and the descriptions thereof are omitted.

### Setting of Threshold to Program File

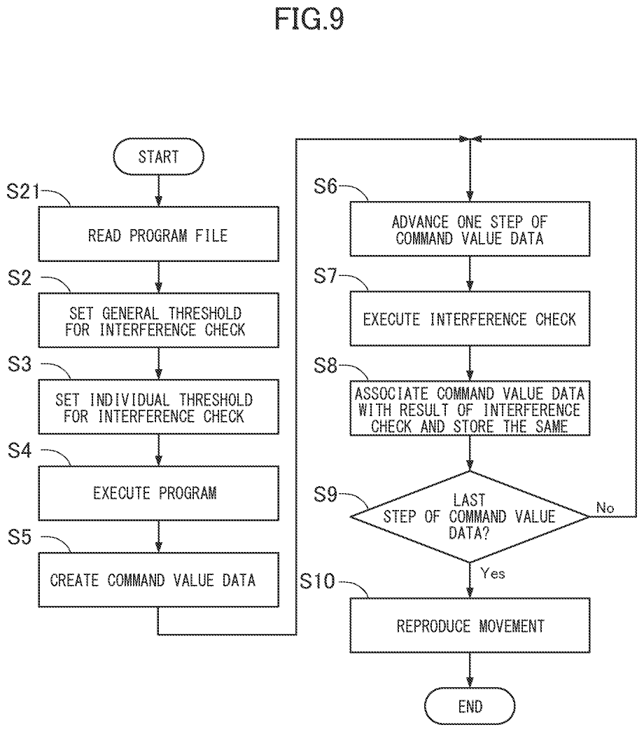

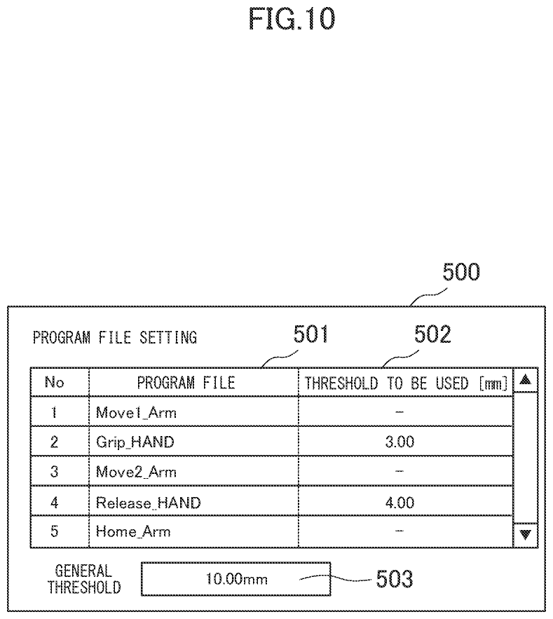

Next, details regarding setting of thresholds to a data file, or program file, of program data executed by the information processing apparatus 200 of the second embodiment will be described with reference to FIGS. 9 and 10. FIG. 9 is a flowchart illustrating reading of a program file and interference check executed by the CPU 212 of the information processing apparatus 200 according to the second embodiment. The flowchart illustrated in FIG. 9 is started by having the program button 301 displayed on the simulation screen 220 illustrated in FIG. 5 operated.

As illustrated in FIG. 9, at first, the CPU 212 reads the program file (S21). In this processing, at first, the CPU 212 calls the program file setting screen based on the program button 301 being selected through the operation of the mouse 204. Then, the CPU 212 displays the program file read from the storage apparatus 216 on the program file setting screen.

FIG. 10 is an explanatory view of a program file setting screen 500 displayed on the display 202 of the second embodiment. As illustrated in FIG. 10, a program file field 501 which is an area for displaying program files that can be read from the storage apparatus 216 is displayed on the program file setting screen 500. Further, a threshold-to-be-used setting 502 which is an area for enabling individual thresholds to be entered per program file is displayed on the program file setting screen 500.

In the second embodiment, the program files capable of being read by the information processing apparatus 200 are each a program file in which a program for moving the robot apparatus 100 is described. In the second embodiment, operation sequences of programs and triggers of execution processing are defined and executed by an execution screen or a software PCL not shown.

In the example illustrated in FIG. 10, programs files “Move1_Arm”, “Grip_HAND”, “Move2_Arm”, “Release_HAND”, and “Home_Arm” can be read as program files.

Among the program files, “Move1_Arm” is the program file in which a program for moving the hand 102 at the tip of the arm 101 to a vicinity of the work W arranged in the small box Ba is described. “Grip_HAND” is a program file in which a program for moving the arm 101, the hand 102, the first finger 103, and the second finger 104 to grip the work W placed in the small box Ba is described. Further, “Move2_Arm” is a program file in which a program for moving the hand 102 at the tip of the arm 101 to a vicinity of the large box Bb is described. “Release_HAND” is a program file in which a program for moving the arm 101, the hand 102, the first finger 103, and the second finger 104 to place the work W being gripped in the large box Bb is described. Further, “Home_Arm” is a program file in which a program for moving the hand 102 at the tip of the arm 101 to the home position is described.

The screen processing unit 213 sets the value entered through the keyboard 203 as the individual threshold of the corresponding program file in a state where the mouse 204 is operated and the threshold-to-be-used setting 502 which is the area on a right side of the program file displayed on the program file field 501 is selected. Further, the screen processing unit 213 displays the value being entered to the threshold-to-be-used setting 502.

Further, a general threshold setting 503 which is an area for setting a general threshold that is set uniformly for program files for which an individual threshold is not set is displayed on the program file setting screen 500. In a state where the general threshold setting 503 is selected by the mouse 204, the screen processing unit 213 sets the value entered through the keyboard 203 as the general threshold and displays the same on the general threshold setting 503.

In the example illustrated in FIG. 10, 10.00 mm is set as the general threshold, such that a threshold of 10.00 mm is set for program files “Move1_Arm”, “Move2_Arm”, and “Home_Arm”.

The CPU 212 stores respective information of the program files displayed on the program file field 501, the individual thresholds entered to the threshold-to-be-used setting 502, and the general threshold entered to the general threshold setting 503 to the storage apparatus 216.

When executing the respective program files, the trajectory calculation unit 214 of the CPU 212 starts to compute the movement of the arm 101A and the movement of the hand 102A, and creates a command value data. The trajectory calculation unit 214 creates command value data of the arm 101A, the hand 102A, the first finger 103A, and the second finger 104A from the start to the end of the program of each program file. The CPU 212 associates the commands of the program described in each program file with the command value data created by the trajectory calculation unit 214, and stores the command value data in the storage apparatus 216.

Then, the interference calculation unit 215 of the CPU 212 acquires the threshold set in program file units as the threshold to be used, and performs the interference check. At first, the interference calculation unit 215 acquires the command of the program associated with the step of the command value data from the storage apparatus 216. Next, the interference calculation unit 215 acquires the information of the threshold set for the program file in which the command of the acquired program is described from the storage apparatus 216. As described above, an individual threshold or a general threshold is set for the program files in which the command of the program is described. In a case where an individual threshold is set for the program file, the interference calculation unit 215 acquires the individual threshold as the threshold to be used for the interference check, and in a case where the individual threshold is not set, it acquires the general threshold as the threshold to be used for the interference check.

### Summary of Second Embodiment

As described, the information processing apparatus 200 according to the second embodiment is configured to enable the threshold to be used for performing the interference check between the first component and the second component to be set for the program files serving as information for defining the movement of the robot apparatus 100. By setting the threshold to be used for the program files in which the programs for moving the plurality of components of the robot apparatus 100 are described, the information processing apparatus 200 can easily execute the interference check with different thresholds set for respective movements of the robot control apparatus. Further, according to this configuration, the information processing apparatus 200 enables to facilitate the management of thresholds and reduce threshold setting errors regardless of the number of components being the target of the interference check and the amount of description of program commands for moving the components.

### Third Embodiment

Next, an information processing apparatus 200 according to a third embodiment will be described. The information processing apparatus 200 according to the third embodiment is configured to enable a threshold to be used for the interference check to be set in a process control block that stores a process to be expanded in the RAM 216b upon executing a program for moving the robot apparatus 100 as information that defines the movement of components. The information processing apparatus 200 according to the third embodiment differs in this point from the first and second embodiments described above. The other configurations are similar to the first and second embodiments, such that components that are similar to the first and second embodiments are denoted with the same reference numbers and control processing that are similar to the first and second embodiments are denoted with the same step numbers, and the descriptions thereof are omitted.

### Setting of Threshold to Process Control Block

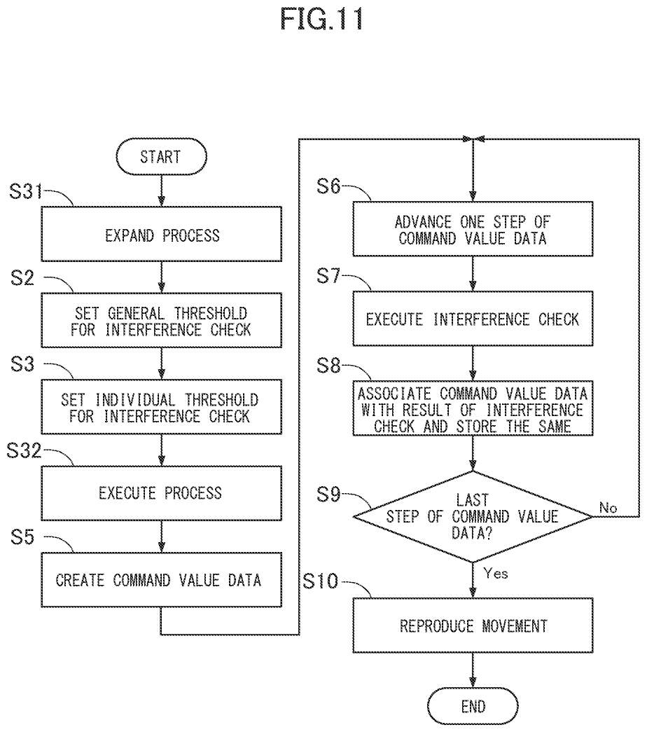

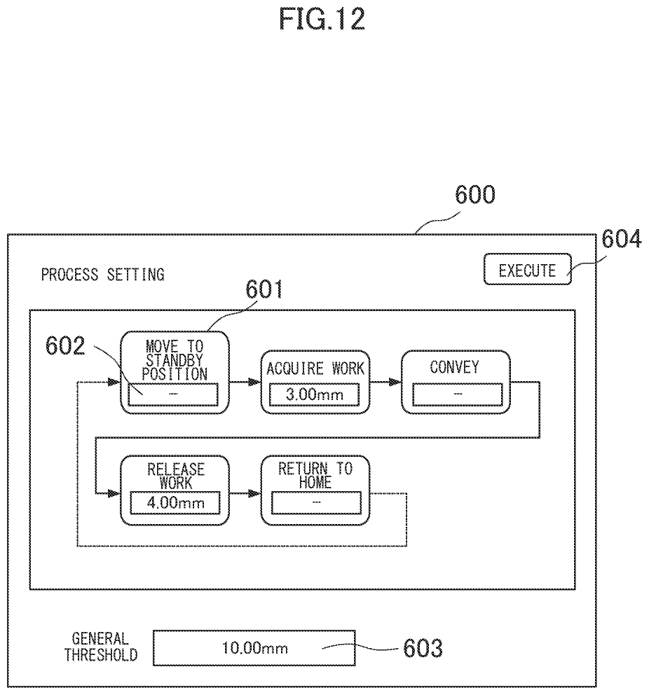

Next, details related to setting thresholds to a process control block executed by the information processing apparatus 200 according to the third embodiment will be described with reference to FIGS. 11 and 12. FIG. 11 is a flowchart illustrating process settings and interference check executed by the CPU 212 of the information processing apparatus 200 according to the third embodiment. The flowchart illustrated in FIG. 11 is started by the program button 301 displayed on the simulation screen 220 illustrated in FIG. 5 being operated.

As illustrated in FIG. 11, at first, the CPU 212 expands the process (S31). In this processing, at first, the CPU 212 calls the process setting screen based on the program button 301 being selected by the operation of the mouse 204. Then, the CPU 212 displays the process control block storing the process expanded in the RAM 216b on the process setting screen.

FIG. 12 is an explanatory view of a process setting screen 600 displayed on the display 202 of the third embodiment. As illustrated in FIG. 12, a process setting 601 displaying a plurality of process control blocks each storing a process expanded in the RAM 216b is displayed on the process setting screen 600. Further, a threshold-to-be-used setting 602 which is an area capable of having an individual threshold per process control block entered is displayed on the process setting screen 600. Further, a general threshold setting 603 which is an area for setting a general threshold that is set uniformly for process control blocks whose individual thresholds are not set is displayed on the process setting screen 600. Further, a process execution button 604 for executing respective processes displayed in the process setting 601 when operated is displayed on the process setting screen 600.

In the example illustrated in FIG. 12, process control blocks of “move to standby position”, “acquire work”, “convey”, “release work”, and “return to home” are provided as process control blocks. The CPU 212 executes the processes “move to standby position”, “acquire work”, “convey”, “release work”, and “return to home” in the named order, and sets the “move to standby position” as the process to be executed after executing “return to home”.

Among the process control blocks, “move to standby position” stores the process for moving the hand 102 at the tip of the arm 101 from the home position to a standby position for acquiring the work W. Further, “acquire work” stores the process for moving the arm 101, the hand 102, the first finger 103, and the second finger 104 to grip the work W positioned in the small box Ba. Further, “convey” stores the process for moving the hand 102 at the tip of the arm 101 to the vicinity of the large box Bb. Further, “release work” stores the process for moving the arm 101, the hand 102, the first finger 103, and the second finger 104 to position the work W being gripped into the large box Bb. Further, “return to home” stores the process for moving the hand 102 at the tip of the arm 101 to the home position.

In a state where the mouse 204 is operated and the threshold-to-be-used setting 602 provided at a lower part of each process control block is selected, the screen processing unit 213 sets the value entered through the keyboard 203 as the individual threshold of the corresponding process control block. Further, the screen processing unit 213 displays the entered value on the threshold-to-be-used setting 602.

Further, in a state where the mouse 204 is operated to select the general threshold setting 603, the screen processing unit 213 sets the value entered through the keyboard 203 as the general threshold and displays the same on the general threshold setting 603.

In the example illustrated in FIG. 12, 10.00 mm is set as the general threshold, such that a threshold of 10.00 mm is set for “move to standby position”, “convey”, and “return to home” among the process control blocks.

The CPU 212 stores respective information of the individual threshold entered to the threshold-to-be-used setting 602 of the process control block and the general threshold entered to the general threshold setting 603 in the storage apparatus 216.

After executing the processing of step S3, the CPU 212 executes the process (S32). In this processing, the CPU 212 executes the processes in order from the process of “move to standby position” by having the process execution button 604 displayed on the process setting screen 600 illustrated in FIG. 12 selected. Further, the CPU 212 is configured to enable the processing of steps S31, S2, and S3 repeatedly executed without executing the processing of step S32 until the process execution button 604 is operated.

Upon executing respective processes, the trajectory calculation unit 214 of the CPU 212 starts to compute the movement of the arm 101A and the movement of the hand 102A and creates a command value data. The trajectory calculation unit 214 creates a command value data of the arm 101A, the hand 102A, the first finger 103A, and the second finger 104A from the start to the end of the program in the respective processes. The CPU 212 associates the commands described in the programs executed in the respective processes with the command value data created by the trajectory calculation unit 214, and stores the command value data in the storage apparatus 216.

Then, the interference calculation unit 215 of the CPU 212 acquires the threshold set for each process control block as the threshold to be used, and performs an interference check. At first, the interference calculation unit 215 acquires the command of the program associated with the step of the command value data from the storage apparatus 216. Next, the interference calculation unit 215 acquires the threshold information set for the process control block storing the process expanded on the RAM 216 for executing the acquired program command from the storage apparatus 216. As described above, an individual threshold or a general threshold is set for the process control block. In a state where an individual threshold is set for the process control block, the interference calculation unit 215 acquires the individual threshold as the threshold to be used for the interference check, and in a state where an individual threshold is not set, the general threshold is acquired as the threshold to be used for the interference check.

### Summary of Third Embodiment

As described above, the information processing apparatus 200 of the third embodiment is configured to enable the threshold to be used for performing the interference check between the first component and the second component to be set for the process control blocks storing the processes for moving the robot apparatus 100. By setting thresholds to be used for the process controls blocks storing processes for moving the plurality of components of the robot apparatus 100, the information processing apparatus 200 can execute the interference check easily by setting different thresholds for different movements of the robot control apparatus. Further, according to this configuration, the information processing apparatus 200 can facilitate the management of thresholds and reduce threshold setting errors regardless of the number of components being the target of the interference check or the amount of description of commands of programs for moving the components.

### Fourth Embodiment

Next, an information processing apparatus 200 according to a fourth embodiment will be described. The information processing apparatus 200 according to the fourth embodiment is configured to enable a plurality of individual thresholds to be set for one information defining the movement of the robot apparatus 100. The information processing apparatus 200 according to the fourth embodiment differs in this point from the first to third embodiments described above. The other configurations are similar to the first to third embodiments, such that components that are similar to the first to third embodiment are denoted with the same reference numbers and control processing that are similar to the first to third embodiments are denoted with the same step numbers, and the descriptions thereof are omitted.

### Multiple Individual Thresholds Set for One Movement

According to the robot system 1, there is a case where the threshold to be used must be changed in response to the change of state when a predetermined movement is performed using the robot apparatus 100. In the robot system 1, for example, if the overall velocity rate of the arm 101 changes, the amplitude of vibration of the arm 101 also changes. Further, according to the robot system 1, for example, the amplitude of vibration varies respectively in acceleration, deceleration, and constant velocity movement of the arm 101. In the robot system 1, a more appropriate threshold can be used by changing the threshold to be used in response to the change of the amplitude of vibration.

Thereby, the information processing apparatus 200 according to the fourth embodiment is configured to enable the threshold to be used to be set according to a rate of velocity, i.e., velocity rate, for one movement, and the threshold to be used to be set according to a time chart for one movement.

### Setting of Threshold to be Used According to Velocity Rate

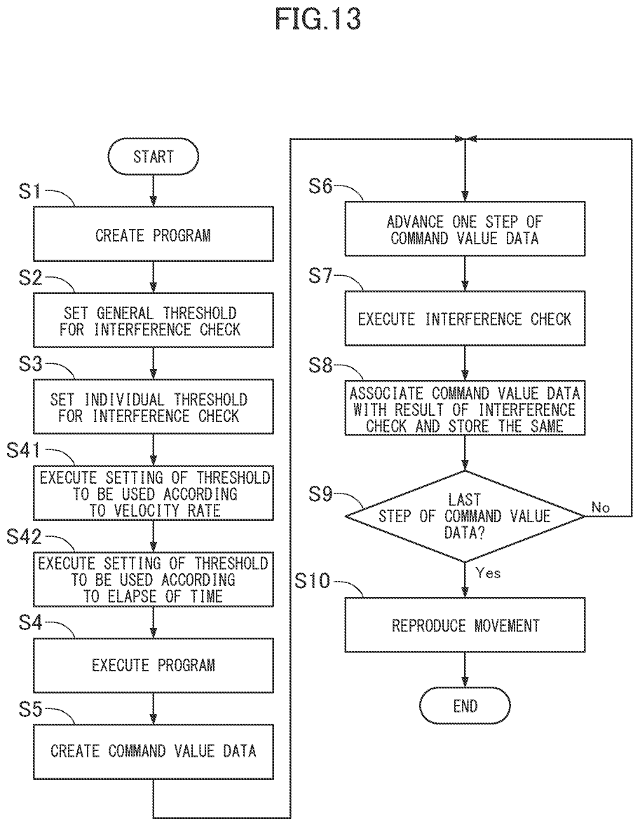

FIG. 13 is a flowchart illustrating a setting of a program and an interference check executed by the CPU 212 of the information processing apparatus 200 according to the fourth embodiment. The flowchart illustrated in FIG. 13 is started by having the program button 301 displayed on the simulation screen 220 operated.

As illustrated in FIG. 13, after executing the processing of step S3, the CPU 212 sets a threshold to be used according to velocity rate (S41). In this processing, based on a selection of a program command entered to the program setting 401 and selection of a button for setting threshold to be used classified by velocity not shown through the operation of the mouse 204, the CPU 212 calls a screen for setting the threshold to be used classified by velocity.

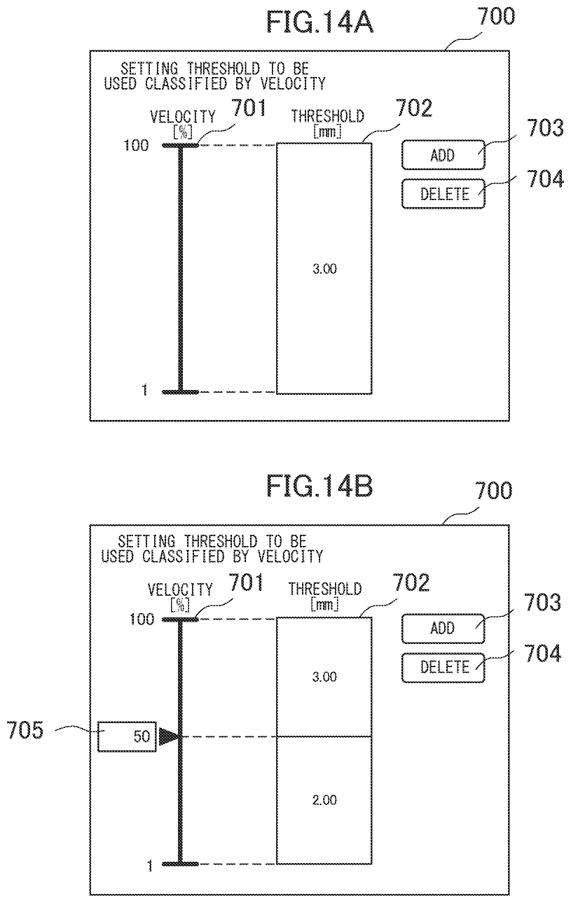

The screen for setting the threshold to be used classified by velocity that is called to set the threshold to be used according to the velocity rate in the information processing apparatus 200 according to the fourth embodiment will be described with reference to FIG. 14. FIG. 14A is an explanatory view illustrating a screen for setting a threshold to be used classified by velocity 700 in a state where one threshold to be used regardless of velocity rate is set, and FIG. 14B is an explanatory view illustrating the screen for setting the threshold to be used classified by velocity 700 in a state where two different thresholds to be used that differ according to velocity rate are set.

As illustrated in FIG. 14A, a velocity rate scale 701 showing velocity rate, a threshold setting 702 displaying the entered threshold to be used, and an add button 703 for adding the threshold according to velocity rate are displayed on the screen for setting the threshold to be used classified by velocity 700. Further, a delete button 704 for deleting the added velocity rate and threshold is displayed on the screen for setting the threshold to be used classified by velocity 700.

The screen processing unit 213 displays a velocity rate entry 705 enabling to enter a velocity rate that divides the velocity rate scale 701 in a case where the add button 703 is selected by the operation of the mouse 204. The screen processing unit 213 divides the velocity rate scale 701 by a numerical value entered to the velocity rate entry 705. Further, based on the addition of the velocity rate entry 705, the screen processing unit 213 divides the area in which the threshold to be used is entered in the threshold setting 702.

In the example illustrated in FIG. 14B, from a state in which 3.00 mm is set as the threshold to be used in any velocity rate from 1 to 100%, 2.00 mm is set as the threshold to be used in the velocity rate of 1 to 50%. According further to the example illustrated in FIG. 14B, 3.00 mm is set as the threshold to be used in the velocity rate from 51 to 100%.

In the information processing apparatus 200, a velocity rate at which the threshold to be used is changed can be varied by changing the numerical value entered to the velocity rate entry 705. Further according to the information processing apparatus 200, by the delete button 704 being selected by the operation of the mouse 204 in the state illustrated in FIG. 14B, the screen is returned to the state illustrated in FIG. 14A.

Further, the information processing apparatus 200 is configured to enable a plurality of thresholds to be used according to velocity rate to be displayed on the threshold-to-be-used setting 402 of the program setting screen 400 illustrated in FIG. 7. In a state where a threshold to be used classified by velocity rate illustrated in FIG. 14B is entered, for example, the information processing apparatus 200 displays “1-50%: 2.00, 51-100%: 3.00” in the threshold-to-be-used setting 402.

During execution of the interference check, the CPU 212 compares an overall velocity of a component in the program being executed with the velocity rate set in the screen for setting the threshold to be used classified by velocity 700, and acquires the value of the threshold to be used for the interference check to perform the interference check.

As described, the information processing apparatus 200 according to the fourth embodiment is configured to enable setting of a threshold of 2.00 mm for 1-50% and a threshold of 3.00 mm for 51-100% of the ratio of velocity in the movement of the component. Thereby, the information processing apparatus 200 can set the distance between components being the target of interference check to an appropriate distance corresponding to the change of velocity rate of the movement of the component.

Further, the information processing apparatus 200 sets a greater threshold as the threshold of 3.00 mm corresponding to the velocity rate of 51-100% than the threshold of 2.00 mm corresponding to the velocity rate of 1-50%. In other words, the information processing apparatus 200 can set a greater value as the threshold in a case where the velocity of movement of the component is high and interference between components is likely to occur, by which the possibility of preventing actual interference from occurring can be increased through the interference check.

According to this configuration, the information processing apparatus 200 can set the distance between components being the target of interference check to an appropriate distance corresponding to the change of velocity rate of the movement of the component.

The velocity rate of 1-50% constitutes a first rate, and a threshold of 2.00 mm corresponding to the velocity rate of 1-50% constitutes a first threshold corresponding to the first rate. Further, the velocity rate of 51-100% which is a velocity higher than the rate of 1-50% constitutes a second rate, and a threshold of 3.00 mm corresponding to the velocity rate of 51-100% constitutes a second threshold corresponding to the second rate.

### Setting of Threshold to be Used According to Time Chart

After executing the processing of step S41, the CPU 212 performs a setting of threshold to be used according to elapsed time (S42). In this processing, based on the program command entered to the program setting 401 being selected and a threshold-to-be-used setting button on time chart not shown being selected by the operation of the mouse 204, the CPU 212 calls a screen for setting a threshold to be used on time chart.

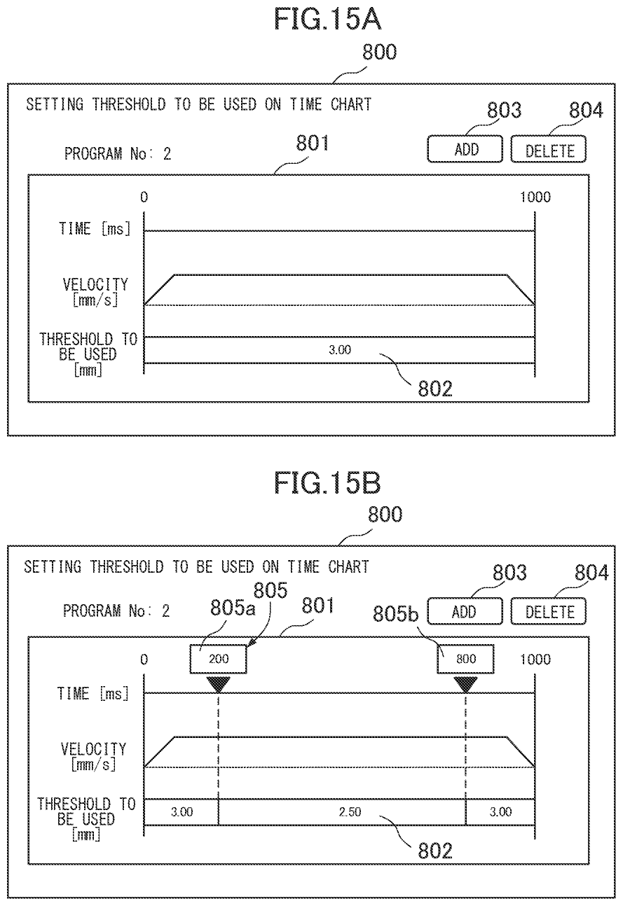

A screen for setting a threshold to be used on time chart that is called to set the threshold to be used based on a time chart in the information processing apparatus 200 according to the fourth embodiment will be described with reference to FIG. 15. FIG. 15A is an explanatory view illustrating a screen for setting a threshold to be used on time chart 800 in a state where one threshold to be used is set regardless of elapsed time, and FIG. 15B is an explanatory view illustrating the screen for setting the threshold to be used on time chart 800 in a state where thresholds to be used that differ according to elapsed time are set.

The examples illustrated in FIGS. 15A and 15B show a time chart in a case where command No. 2 of the program setting 401 which is an operation of movement from the teaching point P2 to the teaching point P3 illustrated in FIG. 8 is executed. As illustrated in FIGS. 15A and 15B, when executing command No. 2 of the program setting 401, the robot apparatus 100 accelerates the arm 101 from a stopped state to a predetermined velocity, and after moving the arm 101 at a predetermined velocity, decelerates the arm 101 until it comes to a stopped state.

As illustrated in FIG. 15A, a time chart 801 illustrating a time chart, a threshold-to-be-used setting 802 displaying the threshold to be used being entered, and an add button 803 for adding a threshold according to elapsed time are displayed on the screen for setting the threshold to be used on time chart 800. Further, a delete button 804 for deleting the threshold being added is displayed on the screen for setting the threshold to be used on time chart 800.

An elapsed time during movement of the robot apparatus 100 by the program command No. 2 and a velocity of the tip of the arm 101 are displayed on the time chart 801. Further, time from 0 to 1000 ms is displayed on the time chart 801, and in the example illustrated in FIG. 15A, 3.00 mm is set as the threshold to be used on the threshold-to-be-used setting 802.

The screen processing unit 213 displays a division time entry 805 capable of entering a time for dividing the time chart 801 when the add button 803 has been selected by the operation of the mouse 204. The screen processing unit 213 divides the time chart 801 by a numerical value entered to the division time entry 805. Further, based on the addition of the division time entry 805, the screen processing unit 213 divides the area in which the threshold to be used is entered on the threshold-to-be-used setting 802.

In the example illustrated in FIG. 15B, by having the add button 803 selected twice, two division times, which are the division time entries 805a and 805b, can be entered. In the example illustrated in FIG. 15B, value “200” is entered to the division time entry 805a, and value “800” is entered to the division time entry 805b.

Thereby, on the screen for setting the threshold to be used on time chart 800, thresholds to be used can be set to correspond respectively to elapse of time 0 to 200 ms, elapse of time 201 to 800 ms, and elapse of time 801 to 1000 ms.

In the example illustrated in FIG. 15B, 3.00 mm is set as the threshold to be used for the elapse of time from 0 to 200 ms, and 2.50 mm is set as the threshold to be used for the elapse of time from 201 to 800 ms. Further, in the example illustrated in FIG. 15B, 3.00 mm is set as the threshold to be use from the elapse of time from 801 to 1000 ms.

As illustrated in FIG. 15B, from the elapse of time from 0 to 200 ms, the robot apparatus 100 accelerates the arm 101 from the stopped state, and moves the arm 101 at a predetermined velocity. Further, from the elapse of time from 201 to 800 ms, the robot apparatus 100 continues to move the arm 101 at a predetermined velocity. Then, from the elapse of time from 801 to 1000 ms, the robot apparatus 100 decelerates the arm 101 having been move at a predetermined velocity until it is in the stopped state.

According to the information processing apparatus 200, the elapse of time for changing the threshold to be used can be changed by changing the numerical value entered to the division time entry 805. Further according to the information processing apparatus 200, when the delete button 804 is selected by the operation of the mouse 204 in the state illustrated in FIG. the screen returns to the state illustrated in FIG. 15A.

Further, the information processing apparatus 200 is configured to enable a plurality of thresholds to be used according to velocity rate to be displayed on the threshold-to-be-used setting 402 of the program setting screen 400 illustrated in FIG. 7 by having different thresholds to be used entered per elapse of time. For example, if different thresholds to be used classified by velocity rate are entered as illustrated in FIG. 15B, the information processing apparatus 200 displays “0-200 ms: 3.00, 201-800 ms: 2.50, 801-1000 ms: 3.00” on the threshold-to-be-used setting 402.

Upon executing the interference check, the CPU 212 compares the time elapsed in the program being executed with the elapse of time set in the screen for setting the threshold to be used on time chart 800, and acquires the value of the threshold to be used for the interference check to perform the interference check.

As described above, in the robot apparatus 100, the arm 101 is accelerated from the stopped state until time from 0 to 200 ms has elapsed. In the robot apparatus 100, the arm 101 is continued to be moved in the predetermined velocity until time from 201 ms to 800 ms has elapsed. Thereafter, in the robot apparatus 100, the arm 101 is decelerated from the state being moved at a predetermined velocity to being stopped until time 801 to 1000 mas has elapsed.

That is, in the robot apparatus 100, there is a possibility that the amplitude of vibration of the arm 101 may become great by the change of velocity of the arm 101 during the elapse of time from 0 to 200 ms and during the elapse of time from 801 to 1000 ms. Further, in the robot apparatus 100, since the arm 101 moves at a predetermined velocity during the elapse of time from 201 to 800 ms, the possibility of the amplitude of vibration of the arm 101 becoming great is smaller than during acceleration or deceleration.

Therefore, the information processing apparatus 200 according to the fourth embodiment is configured to enable setting of the threshold of 3.00 ms for the elapse of time from to 200 ms and the threshold of 2.50 ms for the elapse of time from 201 to 800 ms in the time chart of the movement of the component. Further, the information processing apparatus 200 is configured to enable setting of the threshold of 3.00 ms for the elapse of time from 801 to 1000 ms.

According to this configuration, the information processing apparatus 200 is capable of setting the distance between components being the target of the interference check to an appropriate distance according to the elapsed time of movement of the component.

This elapse of time from 0 to 200 ms constitutes a first time, and a threshold of 3.00 mm corresponding to the elapse of time from 0 to 200 ms constitutes a first threshold corresponding to the first time. Further, the elapse of time from 201 to 800 ms constitutes a second time, and a threshold of 2.50 mm corresponding to the elapse of time from 201 to 800 ms constitutes a second threshold corresponding to the second time. Further, the elapse of time from 801 to 1000 ms constitutes a third time, and a threshold of 2.50 ms corresponding to the elapse of time from 801 to 1000 ms constitutes a third threshold corresponding to the third time.

### Summary of Fourth Embodiment

As described above, the information processing apparatus 200 of the fourth embodiment is configured to enable different thresholds to be used to be set according to the velocity rate in the movement of the component. According to this configuration, the information processing apparatus 200 can set the distance between components being the target of the interference check to an appropriate distance according to the change of velocity rate of the movement of the component. Further, an interference check having different thresholds set for respective velocities in the movement of the robot control apparatus can be executed easily.

Further, the information processing apparatus 200 of the fourth embodiment is configured to enable different thresholds to be used to be set according to the elapsed time in the movement of the component. According to this configuration, the information processing apparatus 200 can set the distance between components being the target of the interference check to an appropriate distance according to the elapsed time of movement of the component.

### Other Embodiments

In the first to fourth embodiments, the robot apparatus 100 adopts a configuration in which the work, or target object, is gripped by fingers, which are the first finger 103 and the second finger 104, but the present technique is not limited thereto. The robot apparatus 100 can adopt a configuration in which a suction mechanism using air is provided on the hand 102, for example, and in which the work is sucked by the suction mechanism.

Further according to the first to fourth embodiments, the information processing apparatus 200 is configured to set thresholds regarding the information that defines the movement of the first component, but the present technique is not limited thereto. If the information processing apparatus 200 includes a component capable of executing movement by a program as a second component, it is possible to adopt a configuration in which the threshold used for the interference check is set regarding the information that defines the movement of the second component.

Further according to the first to fourth embodiments, in setting a threshold for the information that defines the movement of the first component, the information processing apparatus 200 is configured to set thresholds individually for each information, but the present technique is not limited thereto. The information processing apparatus 200 can be configured to set a threshold uniformly for all the information that defines the movement of the first component or the second component. Moreover, the information processing apparatus 200 can be configured to set a common threshold for a plurality of arbitrary information among the information defining the movement of the first component or the second component.

Further according to the fourth embodiment, the information processing apparatus 200 is configured to enable a greater threshold to be set in a case where the velocity rate is high, but the present technique is not limited thereto. The information processing apparatus 200 can set a threshold of 3.00 mm for a velocity rate of 1 to 50% and set a threshold of 2.00 mm for a velocity rate of 51 to 100% among the velocity rate of movement of the component.

According further to the first to fourth embodiments, the information processing apparatus 200 is configured to execute an interference check between two components, but the present technique is not limited thereto. The information processing apparatus 200 can be configured to execute an interference check among three or more components.

Further according to the first to fourth embodiments, the information processing apparatus 200 determines in the interference check that the state is a warning state if the distance between components being the target of interference check is greater than zero and equal to or smaller than the threshold to be used, but the present technique is not limited thereto. The information processing apparatus 200 can be configured to determine that the state is a warning state if the distance between components being the target of interference check is greater than zero and smaller than a threshold to be used, and to determine that the state is not a warning state if the distance is equal to or greater than the threshold to be used.

The information processing method and the information processing apparatus according to the present invention can be applied, in addition to production facilities, to designing of software and creating of programs for various machines and facilities such as industrial robots, service robots, and processing machineries that are operated by numerical value control using a computer. For example, the present technique can be applied to machines and facilities that can perform automatic operations such as expansion and contraction, bending and stretching, moving up and down, moving right and left, and revolving, or a combination of such operations, based on the information from a storage apparatus provided in the control apparatus.

Further, a program for realizing one or more functions of the embodiments described above can be supplied to a system or an apparatus via a network or a storage medium and realized by a processing performed by one or more processors of the computer of the system or the apparatus read and execute the program. Furthermore, it can be realized by a circuit for realizing one or more functions, such as an ASIC.

The present technique is not limited to the embodiments described above, and various modifications are made possible within the technical scope of the present invention. For example, the different embodiments described above can be realized in combination. Further, effects described in the embodiments are mere examples of preferable effects that are exerted by the present technique, and the effects of the present technique are not limited to those described in the embodiments.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-114130, filed Jul. 15, 2022, which is hereby incorporated by reference herein in its entirety.

What is claimed is:

1. An information processing method comprising:
in performing an interference confirmation between a first component and a second component, executing a threshold setting processing of setting a threshold for a piece of information that defines a movement of the first component or the second component; and
executing an interference confirmation processing of performing the interference confirmation using the threshold set for the information.

2. The information processing method according to claim 1,
wherein the information is included in a plurality of pieces of information that defines a plurality of movements of the first component and/or the second component, and
wherein the threshold setting processing includes an individual threshold setting processing of setting thresholds individually for the plurality of pieces of information.

3. The information processing method according to claim 2,
wherein the threshold setting processing includes a general threshold setting processing of setting a threshold uniformly for information for which the thresholds are not set among the plurality of pieces of information in the individual threshold setting processing.

4. The information processing method according to claim 1, wherein the information is a command of a program for moving the first component or the second component.

5. The information processing method according to claim 1, wherein the information is a data file of a program data for moving the first component or the second component.

6. The information processing method according to claim 1, wherein the information is a process control block that stores a process for moving the first component or the second component.

7. The information processing method according to claim 1, wherein, in the threshold setting processing, a first threshold corresponding to a first rate and a second threshold corresponding to a second rate among a velocity rate in the movement can be set.

8. The information processing method according to claim 7,
wherein a velocity of the second rate is higher than a velocity of the first rate, and
wherein the second threshold is greater than the first threshold.

9. The information processing method according to claim 1, wherein, in the threshold setting processing, a first threshold corresponding to a first time and a second threshold corresponding to a second time among a time being elapsed in the movement can be set.

10. An information processing apparatus configured to
in performing an interference confirmation between a first component and a second component, execute a threshold setting processing of setting a threshold for an information that defines a movement of the first component or the second component; and
execute an interference confirmation processing of performing the interference confirmation using the threshold set for the information.

11. A robot system comprising:
the information processing apparatus according to claim 10, and
wherein the first component or the second component includes a work, and a robot hand capable of gripping the work.

12. The robot system according to claim 11, further comprising:
a control apparatus configured to control the robot hand; and
a display apparatus configured to display information communicated by the control apparatus and the information processing apparatus,
wherein the information processing apparatus performs operation of the robot hand and simulation according to the information displayed on the display apparatus, and
wherein the interference confirmation is included in the simulation.

13. A manufacturing method of a product comprising:
manufacturing a product using the robot system according to claim 11.

14. A non-transitory computer-readable storage medium configured to store a program for executing the information processing method according to claim 1 by a computer.
